(19) United States
(12) Patent Application Publication
(10) Pub. No.: US 2016/0327746 A1
(43) Pub. Date: Nov. 10, 2016

(54) BIDIRECTIONAL OPTICAL MULTIPLEXING EMPLOYING A HIGH CONTRAST GRATING

(71) Applicant: HEWLETT-PACKARD DEVELOPMENT COMPANY, L.P., Houston, TX (US)

(72) Inventors: Sagi Varghese Mathai, Sunnyvale, CA (US); Michael Renne Ty Tan, Menlo Park, CA (US); Georgios Panotopoulos, Berkeley, CA (US); Wayne Victor Sorin, Mountain View, CA (US); Paul Kessler Rosenberg, Sunnyvale, CA (US)

(73) Assignee: HEWLETT-PACKARD DEVELOPMENT COMPANY, L.P., Houston, TX (US)

(21) Appl. No.: 15/107,826

(22) PCT Filed: Jan. 25, 2014
(86) PCT No.: PCT/US2014/013078

§ 371 Date: Jun. 23, 2016

(51) Int. Cl. G02B 6/293

(52) U.S. Cl. CPC G02B 6/29367; G02B 6/2938; G02B 6/29308; G02B 6/2931; G02B 6/29311

(57) ABSTRACT

Bidirectional optical multiplexing employs a high contrast grating as one or both of a beam-forming lens and a relay mirror. A bidirectional optical multiplexer includes the beam-forming lens to focus light. The light is one or both of a light beam internal to and another light beam external to the bidirectional optical multiplexer. The bidirectional optical multiplexer further includes an optical filter and the relay mirror. The optical filter is to selectively pass a portion of the internal light beam at a first wavelength and to reflect portions of the internal light beam at other wavelengths. The relay mirror is to reflect the internal light beam along a zigzag propagation path between the optical filter and the relay mirror.

### CROSS-REFERENCE TO RELATED APPLICATIONS

N/A

### STATEMENT REGARDING FEDERALLY SPONSORED RESEARCH OR DEVELOPMENT

N/A

### BACKGROUND

Optical data systems or more generally optical communication systems including, but not limited to, those used in large data centers, often must accommodate large amounts of data using a finite number of optical interconnects. In particular, in many optical communications systems, optical fibers are typically used to interconnect system elements. Increasing an amount of data handled by the optical communications system may lead to a demand for optical fiber interconnects that exceeds the available number of optical fibers in the existing optical communications system. In other instances, various factors such as, but not limited to, physical space and cost, may limit the number of available optical fibers in an optical communications system. In turn, the limited number of available optical fibers may lead to interconnection demand that outstrips the available optical fibers of the optical communication system. While more optical fibers often may be added to accommodate the demand, adding optical fibers may be costly and in some cases impractical. Multiplexing may be a means for scaling interconnection capacity of an optical communication system without needing to add additional optical fibers. Among various multiplexing schemes, wave division multiplexing is often used in conjunction with optical communication systems.

In wave division multiplexing (WDM), a plurality of different wavelengths of light is combined in a single fiber to carry the data. Using a plurality of different wavelengths takes advantage of an inherently wide spectral range of many optical fibers. In particular, WDM combines or ‘multiplexes’ a plurality of optical signals (i.e., optical carrier signals) on a single optical fiber by assigning each optical signal of the plurality to a different wavelength of light. Assigning different optical signals to different wavelengths of light carried by a single optical fiber allows an optical fiber using WDM to take the place of multiple optical fibers carrying single, non-WDM optical signals. Moreover, WDM may facilitate two-way or ‘bidirectional’ transmission (i.e., transmission and reception) of optical signals using the single optical fiber. Specifically, a first set of wavelengths may carry a set of optical signals in a first or upstream direction, while simultaneously a second set of wavelengths may carry a second set of optical signal in a second or downstream direction within the single optical fiber. As such, WDM both increases a number of optical signals that can be carried by the single optical fiber and may facilitate bidirectional communication over the single optical fiber.

In typical WDM systems, a WDM multiplexer is employed to combine (i.e., multiplex) the plurality of optical signals onto a beam of light carried by the single fiber. Another WDM multiplexer may be employed to demultiplex the light beam (i.e., the WDM light beam). In other WDM systems, a single WDM multiplexer may be used to both multiplex and demultiplex the WDM light beam. In particular, a bidirectional WDM multiplexer may be employed to both multiplex a plurality of upstream optical signals transmitted by the bidirectional WDM multiplexer and demultiplex another plurality of downstream optical signals received by the bidirectional WDM multiplexer, for example.

### BRIEF DESCRIPTION OF THE DRAWINGS

Various features of examples in accordance with the principles described herein may be more readily understood with reference to the following detailed description taken in conjunction with the accompanying drawings, where like reference numerals designate like structural elements, and in which:

FIG. 1 illustrates a perspective view of a high contrast grating, according to an example consistent with the principles described herein.

FIG. 2 illustrates a cross-sectional view of a bidirectional optical multiplexer, according to an example of the principles described herein.

FIG. 3 illustrates a cross-sectional view of a bidirectional optical multiplexer, according to another example consistent with the principles described herein.

FIG. 4 illustrates a cross-sectional view of a bidirectional optical multiplexing system, according to an example consistent with the principles described herein.

FIG. 5 illustrates cross-sectional view of a bidirectional optical multiplexing system, according to another example consistent with the principles described herein.

FIG. 6 illustrates a flow chart of a method of bidirectional optical multiplexing, according to an example consistent with the principles described herein.

Certain examples have other features that are one of in addition to and in lieu of the features illustrated in the above-referenced figures. These and other features are detailed below with reference to the above-referenced figures.

### DETAILED DESCRIPTION

Examples in accordance with the principles described herein provide bidirectional optical multiplexing using a high contrast grating. In particular, a high contrast grating is configured as one or both of a lens to focus light and a mirror to reflect light in bidirectional optical multiplexing, according to various examples of the principles described herein. Further, according to various examples, wavelength selective optical filters along a zigzag propagation path facilitate separation of various wavelengths of a light beam used in bidirectional zigzag multiplexing. As such, bidirectional optical multiplexing may implement wave division multiplexing, according to various examples. Moreover, the wave division multiplexing is bidirectional to support both transmission and reception of optical signals separated according to wavelength, for example.

Herein, a high contrast grating is defined as a sub-wavelength diffraction grating having a large refractive index contrast. In particular, the large refractive index contrast of the high contrast grating may be provided by grating elements (e.g., strips, bars, posts, etc.) having a relatively high refractive index that are substantially surrounded by a material or a medium having a relatively low refractive index, according to some examples. For example, the high contrast grating may include a plurality of spaced-apart bars (i.e., the grating elements) of a high refractive index or ‘high index’ material (e.g., silicon, aluminum gallium arsenide, etc.) surrounded by air, silicon dioxide, aluminum oxide or another relatively low refractive index or ‘low index’ material. In other examples, the low index material is only between the grating elements that include the high index material. In yet other examples, the low index material may be between the grating elements and also one of above or below the grating elements that include the high index material. According to various examples, one or both of the high index material and the low index material is selected to be substantially transparent at an operational wavelength of the high contrast grating.

In some examples, the high contrast grating includes the same low index material or medium between each of the high index grating elements as well as above and below the high index grating elements. In other examples, a material between the high index grating elements includes a first low index material, while a second low index material is one or both of above and below the high index grating elements. In yet other examples, a material above the high index grating elements is the second low index material and a third low index material is below the high index grating elements.

According to various examples, a difference between the refractive index of the high index material and the refractive index of the low index material is determined by a particular application or use of the high contrast grating including, but not limited to, an operational wavelength of the high contrast grating. In some examples, the relatively high refractive index may be about 2 times or more greater than the relatively low refractive index. For example, the grating elements may including a material having a refractive index that is greater than about 2.0 and the material or medium surrounding the grating elements may have a refractive index of about 1.0. In another example, the high index material may have a refractive index of about 3.5 (e.g., silicon, germanium, etc.) and the low index material may have a refractive index of between about 1.0 and about 2.0 (e.g., silicon dioxide, germanium dioxide).

According to some examples, the high contrast grating is substantially planar and may be characterized as either a one-dimensional (1-D) grating structure or a two-dimensional (2-D) grating structure. In particular, the high contrast grating may be implemented in a substantially planar layer as a 1-D or 2-D array of high contrast grating elements. For example, a 1-D high contrast grating may include a plurality of substantially parallel bars or strips arranged in a planar layer. In another example, a quasi-2D high contrast grating may include a plurality of curved bars or strips, or bars whose width is varied along a length of the bar. In yet another example, a plurality of spaced-apart rectangular, circular or elliptical, etc., elements arranged in a layer as a 2-D array may provide a 2-D high contrast grating. According to various examples, the high contrast grating may be either a periodic grating or a substantially non-periodic (i.e., aperiodic) grating.

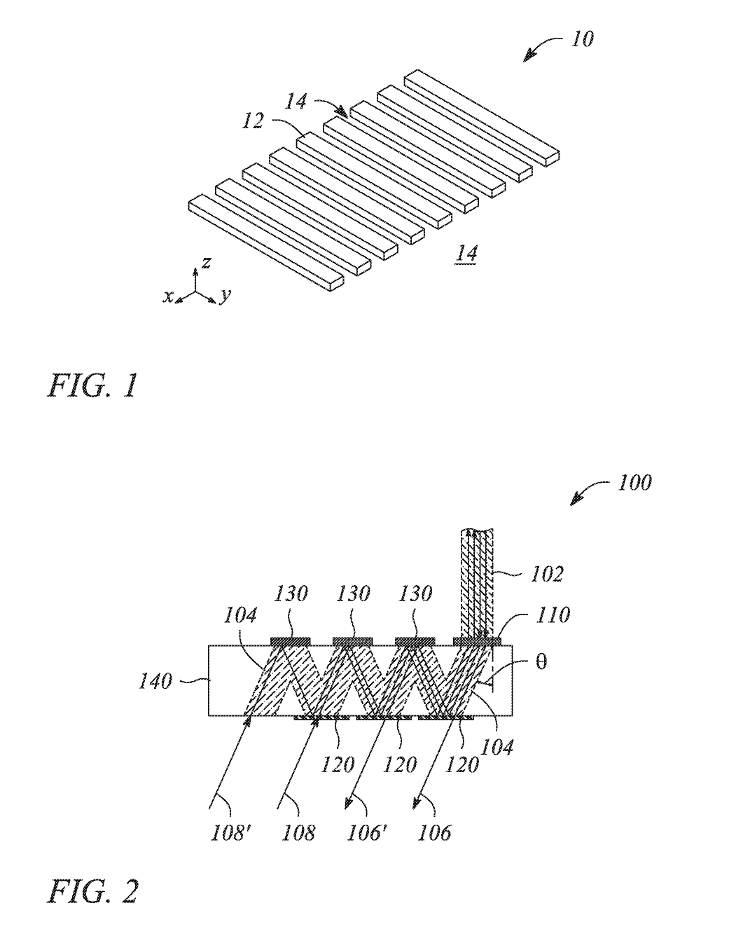

FIG. 1 illustrates a perspective view of a high contrast grating 10, according to an example consistent with the principles described herein. In particular, the high contrast grating 10 illustrated in FIG. 1 is a 1-D high contrast grating 10. The high contrast grating 10 includes a plurality of substantially parallel, rectangular bars 12 arranged in a planar layer (e.g., a layer in an x-y plane, as illustrated). A center-to-center spacing between the rectangular bars 12 is less than a wavelength at which the high contrast grating 10 is to be operated or used (i.e., an operational wavelength). The rectangular bars 12 include a material having a high refractive index and are surrounded by a medium 14 having a low refractive index. For example, the rectangular bars 12 may include silicon, while the medium 14 may include silicon dioxide or air.

Herein, a high contrast grating (HCG) lens is defined as a high contrast grating configured to function as a lens to focus, tilt, or collimate light. Further, by definition herein, the HCG lens includes a high contrast grating having a grating pitch small enough to substantially suppress all but a zeroth (0^{th}) order diffraction mode at an operational wavelength of the HCG lens. According to various examples, all higher order diffraction modes are below a cutoff at the operational wavelength of the HCG lens. In particular, by definition herein, the HCG lens is a non-periodic, high contrast grating that supports only the zeroth order diffraction mode and that is configured to provide a predetermined phase front modification to the light passing through the HCG lens, where the phase front modification is consistent with that of a lens (e.g., the HCG lens acts to bend and focus light). For example, the phase front modification may be consistent with that provided by a refractive lens.

In some examples, one or both of a spacing between grating elements and a width or size of the grating elements of the HCG lens is varied as a function of distance across or along a grating structure of the HCG lens to provide the predetermined phase front modification. In some examples, the HCG lens may be a 1-D lens in which the pre-determined phase front modification is provided in only one direction (e.g., an x-direction substantially parallel to a plane of the HCG lens). In other examples, the HCG lens is a 2-D lens configured to provide the predetermined phase front modification in two substantially orthogonal directions (e.g., an x-direction and ay-direction). According to various examples, the predetermined phase front modification provided by the HCG lens may correspond to or be consistent with a phase front modification provided by substantially any arbitrary lens (e.g., any refractive lens design or shape). For example, the predetermined phase front modification of or provided by the HCG lens may be consistent with that of a convex lens (e.g., refractive plano-convex, refractive biconvex, etc.). In some examples, the HCG lens may implement a collimating lens. In some examples, the HCG lens may implement an off-axis or tilted beam lens.

Herein, a ‘high contrast grating (HCG) mirror’ is defined as a high contrast grating configured to function as a mirror to reflect light. In some examples, the HCG mirror merely reflects light. In other examples, the HCG mirror may both reflect and focus or collimate light. In particular, the HCG mirror may represent a so-called shaped mirror. The shape of the shaped mirror may be substantially parabolic, for example.

According to various examples, light propagates within a bidirectional optical multiplexer, as described herein, along a zigzag propagation path. Herein, a ‘zigzag propagation path’ may be defined as a continuous path of optical propagation that includes least two points of reflection resulting in at least two abrupt changes in direction of propagating light within the path. Further, by some definitions, the zigzag propagation path may have at least two portions of the path that are substantially parallel to one another (i.e., in the same direction), while an intervening portion of the path is substantially not parallel with the other two portions. For example, a zigzag propagation path may describe a path followed by a light beam bouncing between and along two spaced apart, substantially parallel, reflective planes, where an initial angle of incidence of the light beam on a first reflective plane is greater than zero degrees and less than ninety degrees.

As defined herein, a ‘tilt’ of a light beam is a change in a propagation direction of the light beam. In particular, tilt represents a propagation direction change of the light beam that may be provided by a lens, for example. The propagation direction change may be a difference in a propagation direction on either side of the lens, according to various examples.

Further, as used herein, the article ‘a’ is intended to have its ordinary meaning in the patent arts, namely ‘one or more’. For example, ‘a lens’ means one or more lenses and as such, ‘the lens’ means ‘the lens(es)’ herein. Also, any reference herein to ‘top’, ‘bottom’, ‘upper’, ‘lower’, ‘up’, ‘down’, ‘front’, back’, ‘left’ or ‘right’ is not intended to be a limitation herein. Herein, the term ‘about’ when applied to a value generally means within the tolerance range of the equipment used to produce the value, or in some examples, means plus or minus 10%, or plus or minus 5%, or plus or minus 1%, unless otherwise expressly specified. Further, herein the term ‘substantially’ as used herein means a majority, or almost all, or all, or an amount with a range of about 51% to about 100%, for example. Moreover, examples herein are intended to be illustrative only and are presented for discussion purposes and not by way of limitation.

FIG. 2 illustrates a cross-sectional view of a bidirectional optical multiplexer 100, according to an example of the principles described herein. The bidirectional optical multiplexer 100 is bidirectional in that it both receives and transmits optical signals. In particular, a light beam 102 external to the bidirectional optical multiplexer 100 (e.g., at an input/output (I/O) port) may contain both a portion or component received by the bidirectional optical multiplexer 100 and another portion or component transmitted by or propagating away from (e.g., exiting) the bidirectional optical multiplexer. As such, the external light beam 102 is a bidirectional light beam, by definition herein.

In FIG. 2, the external light beam 102 is illustrated at a crosshatched region bounded by dashed lines. The received component is illustrated as a pair of arrows within the external light beam 102 that are pointing toward the bidirectional multiplexer 100. The transmitted component is illustrated in FIG. 2 as a pair of arrows within the external light beam 102 that are pointing away from the bidirectional optical multiplexer 100. The received components propagating toward the bidirectional multiplexer 100 also may be referred to as downstream components representing downstream optical signals, while the transmitted components also may be referred to as ‘upstream’ components representing upstream optical signals, for example.

According to various examples, the bidirectional optical multiplexer 100 may separate or demultiplex one or more received components of the external light beam 102 to produce discrete or individual received components (e.g., representing individual received optical signals). Further, the bidirectional optical multiplexer 100 may combine or multiplex one or more transmitted components into the external light beam 102 exiting the bidirectional optical multiplexer 100. Each of the components of the external light beam 102, whether transmitted or received by the bidirectional optical multiplexer 100, may be distinguished according to a wavelength of light that represents the component, according to various examples. As such, the bidirectional optical multiplexer 100 may facilitate bidirectional wavelength division multiplexing (WDM) of the received and transmitted components, according to various examples. For example, the received component may include light of or having a predetermined wavelength that is propagating toward the bidirectional optical multiplexer 100. The transmitted component may include light that is propagating away from the bidirectional optical multiplexer 100, where the light or the transmitted component has a different predetermined wavelength from the received component. As such, received and transmitted components may represent wave division multiplexed optical signals with each optical signal being at a different wavelength in the external light beam 102, according to various examples.

The bidirectional optical multiplexer 100 includes or supports a light beam 104 internal to the bidirectional optical multiplexer 100. The internal light beam 104 may include portions or components that propagate in opposite directions along a propagation path of the internal light beam 104. As such, the internal light beam 104 is also a bidirectional light beam, by definition herein. For example, the components of the internal light beam 104 may include the received and transmitted components of the external light beam 102, according to various examples.

Further, the internal light beam 104 is configured to follow a zigzag propagation path, as will be discussed in further detail below. Thus, the internal light beam 104 also may be referred to as a ‘zigzag’ light beam 104, herein. At different points or locations along the zigzag propagation path of the internal light beam 104, different components at different wavelengths (i.e., the different optical channels) may be either added to or extracted and separated from the internal light beam 104 to facilitate the bidirectional WDM provided by the bidirectional optical multiplexer 100, according to various examples.

As illustrated in FIG. 2, the bidirectional optical multiplexer 100 includes a beam-forming lens 110. The beam-forming lens 110 is configured to focus a beam of light. In some examples, the beam-forming lens 110 both focuses and tilts the light beam. The light beam focused and optionally tilted by the beam-forming lens 110 may be both the external light beam 102 and the internal light beam 104, according to various examples. In particular, a portion or component of the external light beam 102 propagating towards the bidirectional optical multiplexer 100 (e.g., the received component) that passes through the beam-forming lens 110 is focused and tilted to become part of the internal light beam 104. Similarly, the beam-forming lens 110 tilts and focuses a portion of the internal light beam 104 that passes through the beam-forming lens 110 to become part of the external light beam 102 that propagates away from the bidirectional optical multiplexer 100 (e.g., the transmitted component). In general, the beam-forming lens 110 is a reciprocal lens in that the provided tilting and focusing are substantially the same regardless of the propagation direction through the beam-forming lens 110, according to various examples.

According to various examples, the tilt provided by the beam-forming lens 110 facilitates the zigzag propagation path of the internal light beam 104 within the bidirectional optical multiplexer 100. In particular, due to the tilt, the external light beam 102 and the internal light beam 104 have different respective propagation directions, according to various examples. For example, as illustrated in FIG. 2, the external light beam 102 has a propagation direction that is substantially vertical. On the other hand, a propagation direction of the internal light beam 104 differs from vertical by a tilt angle 0, as illustrated.

According to various examples, the tilt angle θ is configured to be greater than zero degrees (>0°) and less than ninety degrees (<90°) relative to the direction of the external light beam 102. For example, the tilt angle θ may be between about ten degrees (1°) and about ten degrees (10°). In another example, the tilt angle θ is between about twenty degrees (20°) and about seventy degrees (70°). In yet another example, the tilt angle θ is between about thirty degrees (30°) and about sixty degrees (60°). For example, the tilt angle θ may be about thirty-five degrees (35°) or about forty-five degrees (45°). The tilt angle θ may be selected to facilitate a predetermined or target spacing between other elements (e.g., relay mirrors, optical sources, photodetectors, etc.) of the bidirectional optical multiplexer 100, according to some examples. In another example, the tilt angle θ is selected to facilitate operation of an element (e.g., an optical filter) or to accommodate a tilt angle of another lens (e.g., an optical source or photodetector lens).

The focusing provided by the beam-forming lens 110 focuses light from the internal and external light beams 102, 104 passing therethrough. In particular, a portion or component of the external light beam 102 propagating from outside to inside the bidirectional optical multiplexer 100 and passing through the beam-forming lens 110 is focused to become part of the internal light beam 104. Similarly, a portion of the internal light beam 104 that passes through the beam-forming lens 110 to exit the bidirectional optical multiplexer 100 is focused to become part of the external light beam 102.

According to some examples, the beam-forming lens 110 may be or include a high contrast grating (HCG) lens. In particular, the beam-forming lens 110 may include a high contrast grating configured to produce both the tilting and the focusing provided by the beam-forming lens 110. The HCG lens may be provided by an HCG layer that is formed or patterned using etching or another means to include the HCG lens, for example. FIG. 2 illustrates the beam-forming lens 110 as an HCG lens (i.e., an HCG layer), for example. The HCG lens may be either a one-dimensional (1-D) or a two-dimensional (2-D) grating, according to various examples. In other examples (not illustrated), the beam-forming lens 110 is a refractive lens (e.g., a convex, dielectric lens).

The bidirectional optical multiplexer 100 illustrated in FIG. 2 further includes an optical filter 120. The optical filter 120 is configured to selectively pass a portion of the internal light beam 104 at a first wavelength and to reflect portions of the internal light beam 104 at other wavelengths. As such, the optical filter 120 is a reflective optical filter (e.g., as opposed to an absorptive optical filter). In some examples, the optical filter 120 may be a bandpass optical filter. For example, the optical filter 120 may be configured to pass light at the first wavelength within a passband of the optical filter 120 and to reflect light at other wavelengths outside of (i.e., above and below) the passband. In other examples, the optical filter 120 may implement either a highpass optical filter or a lowpass optical filter. For example, the first wavelength may be lower than the other wavelengths. The optical filter 120 implemented as a lowpass optical filter may pass the first wavelength, while the other wavelengths beyond a cut-off wavelength of the lowpass filter are reflected.

According to some examples, the optical filter 120 is a dichroic optical filter. In other examples, the optical filter 120 may include a grating and be a grating-based optical filter 120. In some examples, the grating may be a high contrast grating. As such, the optical filter 120 may be a wavelength-selective high contrast grating-based optical filter. In yet other examples, the optical filter 120 may include, but is not limited to, a multilayer dielectric filter and a guided mode resonance filter.

The bidirectional optical multiplexer 100 further includes a relay mirror 130, as illustrated in FIG. 2. The relay mirror 130 is configured to reflect the internal light beam 104. In particular, the internal light beam 104 is reflected by the relay mirror 130 to follow the zigzag propagation path between the relay mirror 130 and the optical filter 120 within the bidirectional optical multiplexer 100. According to some examples, the relay mirror 130 is further configured to collimate the reflected internal light beam 104. In particular, the relay mirror 130 may be a ‘shaped’ mirror that focuses or collimates the light. Collimating the reflected internal light beam 104 may help to reduce or compensate for a spreading of the internal light beam 104 along the zigzag propagation path, according to some examples.

In some examples, the relay mirror 130 includes a high contrast grating. In particular, the relay mirror 130 may be or include a high contrast grating (HCG) mirror, according to some examples. Characteristics of the HCG mirror used as the relay mirror 130 (e.g., grating period, grating element size, grating element shape) may be configured to provide a phase front of the reflected internal light beam 104 consistent with a focused light beam, for example. In other examples, the relay mirror 130 may be a conventional reflector such as, but not limited to, a metalized, multilayer dielectric, or otherwise reflective shaped surface. The shaped surface of the relay mirror 130 may provide the focusing, according to some examples.

As illustrated in FIG. 2, the bidirectional optical multiplexer 100 may include a plurality of optical filters 120 and a plurality of relay mirrors 130, according to some examples. The optical filters 120 may be spaced apart from one another (e.g., in a first plane or on a first surface of a substrate, as described below with respect to a transparent substrate 140). Moreover, the relay mirrors 130 may be spaced apart from one another (e.g., in a second plane or on the second surface of the substrate spaced apart from the first plane or first surface, as described below with respect to the transparent substrate 140). The respective spacing facilitates the zigzag path of the internal light beam 104, for example. For example, the bidirectional optical multiplexer 100 may include three optical filters 120 and three relay mirrors 130, as illustrated FIG. 2. The optical filters 120 and the relay mirrors 130 may be distributed along the zigzag propagation path, as illustrated. Each of the optical filters 120 is configured to selectively pass a different wavelength of the internal light beam 104. Each of the relay mirrors 130 is configured to reflect, and in some examples to also collimate, the reflected internal light beam 104 along the zigzag propagation path between the relay mirrors 130 and the optical filters 102, according to some examples.

In particular, a first optical filter 120 (located closest to the beam-forming lens 110) is configured to selectively pass a first portion of the internal light beam 104 at a first wavelength and to reflect other portions of the internal light beam 104 at wavelengths other than the first wavelength. A second optical filter 120 of the plurality may be configured to selectively pass a second portion of the internal light beam 104 at a second wavelength and to reflect portions of the internal light beam 104 at wavelengths other than the second wavelength, and so on. A first relay mirror 130 of the relay mirror plurality may be configured to reflect the internal light beam 104 from the first optical filter 120 along the zigzag propagation path to the second optical filter 120 within the bidirectional optical multiplexer 100, according to some examples. A second relay mirror 130 of the relay mirror plurality may be configured to reflect the internal light beam 104 from the second optical filter 120 to a third optical filter 120, and so on. The reflected internal light beam 104 may also be collimated by the respective relay mirrors 130, in some examples. Solid lines in FIG. 2 represent various ones of the wavelengths or equivalently components of the internal light beam 104, for example.

In some examples (e.g., as illustrated in FIG. 2), the bidirectional optical multiplexer 100 further includes a transparent substrate 140. The transparent substrate 140 may be located between the optical filter 120 and the relay mirror 130. In particular, the relay mirror 130 may be adjacent to (e.g., on or in) a first surface of the transparent substrate 140. The optical filter 120 may be adjacent to (e.g., on or in) a second surface of the transparent substrate 140 opposite the first surface (e.g., as illustrated).

For example, the relay mirror 130 may be an HCG mirror formed on or otherwise attached to the first surface. Similarly, the optical filter 120 may be formed on, affixed to or otherwise supported by the second surface of the transparent substrate 140. In some examples, the beam-forming lens 110 also may be adjacent to the first surface of the transparent substrate 140. For example, the beam-forming lens 110 may be an HCG lens formed on or otherwise attached to the first surface, as illustrated in FIG. 2. Further (e.g., as illustrated in FIG. 2), the zigzag propagation path of the internal light beam 104 may be substantially within and along a length of the transparent substrate 140, according to various examples.

According to various examples, the transparent substrate 140 is substantially transparent to light at a wavelength of the internal light beam 104. In particular, the transparent substrate 140 is configured to pass the internal light beam 104 with little or no loss, according to various examples. The transparent substrate 140 may include an optically transparent material such as, but not limited to, glass or another dielectric material, for example. In other examples, such as when the internal light beam 104 includes wavelengths in the infrared (IR) range, a semiconductor material including, but not limited to, silicon (Si) gallium arsenide (GaAs), and indium phosphide (InP) may be used for the transparent substrate 140.

As illustrated in FIG. 2, light entering or received by the bidirectional optical multiplexer 100 as part of the external light beam 102 is first focused and tilted by the beam-forming lens 110. The focused and tilted light then propagates through the transparent substrate 140 in a direction away from the beam-forming lens 110 and towards the first optical filter 120 as part of the internal light beam 104. As described herein, the light propagating in the internal light beam 104 away from the beam-forming lens 110 is said to be propagating in a first direction along the zigzag propagation path.

At the first optical filter 120, a portion of the internal light beam 104 at the first wavelength passes through the first optical filter 120 and exits the bidirectional optical multiplexer 100. In FIG. 2, an arrow 106 pointing away from the second surface of the transparent substrate 140 and the first optical filter 120 illustrates the internal light beam portion at the first wavelength that is passed by the first optical filter 120. Note that a component of the internal light beam 104, represented by a solid line that is inline with the arrow 106, is substantially removed by the first optical filter 120 and thus is no longer part of the internal light beam 104 remaining after a first filtering (i.e., to a left of the first optical filter 120), as illustrated in FIG. 2.

Light in the internal light beam 140 and propagating in the first direction along the zigzag propagation path remaining after the first filtering (i.e., that is not at the first wavelength and that is not passed by the first optical filter 120) is reflected by the first optical filter 120 toward a first relay mirror 130. At the first relay mirror 130, the remaining light of the internal light beam 104 propagating in the first direction is reflected toward a second optical filter 120 by the first relay mirror 130. As noted above, the first relay mirror 130 may collimate the reflected light of the internal light beam 104. At the second optical filter 120, a portion of the remaining light of the internal light beam 140 at a second wavelength passes through the second optical filter 120. The light at the second wavelength that is passed by the second optical filter 120 is illustrated by an arrow 106′ in FIG. 2. As with the first optical filter 120, a component of the internal light beam 104, represented by a solid line that is inline with the arrow 106′ is substantially removed by the second optical filter 120. Thus the component 106′ is not part of the remaining light of the internal light beam 104 propagating in the first direction to the left of the second optical filter 120, as illustrated.

Further as illustrated in FIG. 2, light to be transmitted by the bidirectional multiplexer 100 as the transmitted component of the external light beam 102 may be directed toward the second surface of the transparent substrate 140, as illustrated by arrows 108, 108′. In particular, light at a third wavelength, illustrated by arrow 108, may be directed toward the second surface of the transparent substrate 140 through a third optical filter 120 configured to pass the third wavelength. The light at the third wavelength may propagate in the zigzag propagation path as part of the internal light beam 104 through the transparent substrate 140. A solid line inline with the arrow 108 at the third optical filter 120 represents a component of the internal light beam 104 at the third wavelength, as illustrated. Note that herein, light to be transmitted (e.g., the light at the third wavelength) propagates in a second propagation direction along the zigzag propagation path. The second propagation direction is opposite the first propagation direction, by definition herein.

The light at the third wavelength may propagate in the second direction from the third optical filter 120 to a third relay mirror 130, as illustrated by the aforementioned solid line. At the third relay mirror 130, the third wavelength light is reflected toward the second optical filter 120. At the second optical filter 120, the third wavelength light is reflected and directed toward the second relay mirror 130 where it is again reflected. Note that the third wavelength is outside of the passband of the second optical filter 120. The third wavelength light proceeds along the zigzag propagation path in this manner until the beam-forming lens 110 is encountered. At the beam-forming lens 110, the light in the internal light beam 104 at the third wavelength is focused and tilted and then exits the bidirectional optical multiplexer 100 as part of the external light beam 102.

Similarly, light at a fourth wavelength to be transmitted, illustrated by the arrow 108′ in FIG. 2, passes through the second surface of the transparent substrate 140 and may be directed to encounter a third relay mirror 130 at the first surface of the transparent substrate 140, as illustrated by a solid line inline with the arrow 108′. The fourth wavelength light is reflected by the third relay mirror 130 and then follows the zigzag propagation path of the internal light beam 104 in the second propagation direction. In particular, since the fourth wavelength light is not in the passband of any of the optical filters 120 illustrated in FIG. 2, the fourth wavelength light is reflected by the third, second and first optical filters 120 and by the respective third, second and first relay mirrors 130 until the beam-forming lens 110 is encountered. As with the third wavelength light, the fourth wavelength light is focused and tilted by the beam-forming lens 110 and then exits the bidirectional optical multiplexer 100 as part of the external light beam 102 (i.e., as a transmitted component).

According to some examples, the light received by the bidirectional optical multiplexer 100 from the external light beam 102 and exiting the bidirectional optical multiplexer 100 as received light illustrated by arrows 106, 106′ may proceed on to other components of an optical system (not illustrated). For example, the received light 106, 106′ may be passed to one or more optical fibers, to optical amplifiers, lens, filters or other optical system components. In another example (described in more detail below), the received light 106, 106′ is passed to and detected by one or more photodetectors. Similarly, the light to be transmitted as represented by arrows 108, 108′ may be received from other optical system components (e.g., optical fibers, lenses, filters, etc.). In particular, the light to be transmitted 108, 108′ may be emitted by and received from one or more optical source, as described in more detail below.

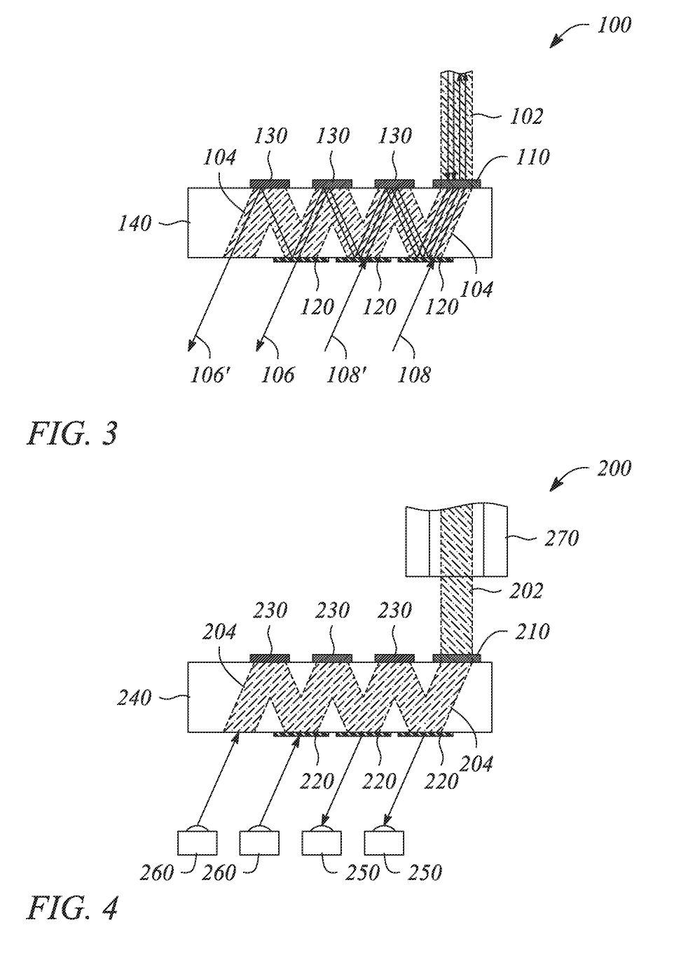

FIG. 3 illustrates a cross-sectional view of a bidirectional optical multiplexer 100, according to another example consistent with the principles described herein. In particular, FIG. 3 illustrates the beam-forming lens 110, and by way of example, three optical filters 120 and three relay mirrors 130, arranged as described in FIG. 2, on opposite surfaces of the transparent substrate 140. However, as illustrated in FIG. 3, passbands of the three optical filters 120 are rearranged relative to the configuration illustrated in FIG. 2. Specifically, as illustrated in FIG. 3, the first optical filter 120 (closest to the beam-forming lens 110) has a passband at the third wavelength, the second optical filter 120 has a passband at the fourth wavelength, and the third optical filter 120 (furthest from the beam-forming lens 110) has a passband corresponding to the first wavelength.

As illustrated in FIG. 3, light to be transmitted may be directed at the second surface of the transparent substrate 140 through the first and second optical filters 120 to propagate in the second direction along the zigzag propagation path of the internal light beam 104 (toward the beam-forming lens 110). In particular, light to be transmitted illustrated by arrows 108, 108′ (at the third and fourth wavelengths), is directed through a first two of the three optical filters 120 having passbands corresponding to the third and fourth wavelengths, for example, as part of the internal light beam 104. This light is focused and tilted by the beam-forming lens 110 and then exits the bidirectional optical multiplexer 100 as part of the external light beam 102 (i.e., as the transmitted component).

Light entering the bidirectional optical multiplexer 100 illustrated in FIG. 3 in the external light beam 102 propagates in the first direction along the zigzag propagation path of the internal light beam 104 and is reflected by the first and second optical filters 120 and respectively the first and second relay mirrors 130. At a third optical filter 120, light of the internal light beam 104 at the first wavelength passes out of the bidirectional optical multiplexer 100 at the second surface of the transparent substrate 140 as received light, as indicated by arrow 106. Further, light of the internal light beam 104 at the second wavelength may exit the bidirectional optical multiplexer 100 as received light after being reflected by the third relay mirror 130, as indicated by arrow 106′. In particular, the light of the internal light beam 104 at the second wavelength and propagating in the first direction may be reflected by all three optical filters 120 as well as all three relay mirrors 130 to exit as illustrated in FIG. 3.

While not explicitly illustrated, other permutations of transmitted light and received light corresponding to other permutations of wavelengths and passbands of the optical filters 120 are clearly possible and are explicitly within the scope of the principles described herein. For example, the beam-forming lens 110 may be located adjacent to the optical filters 120 such that the internal light beam 102 encounters a relay mirror 130 before an optical filter 120. In other examples, optical filters 120 and relay mirror 130 may be interspersed with one another in one or both of the first and second planes (e.g., adjacent to one or both of the first and second surfaces or the transparent substrate 140). As such, the received light 106, 106′ may exit the bidirectional optical multiplexer 100 from both sides thereof. Similarly, the light to be transmitted 108, 108′ may enter from both sides of the bidirectional optical multiplexer 100, instead of just one side as illustrated in FIGS. 2 and 3, for example.

According to some examples of the principles described herein, a bidirectional optical multiplexing system is provided. The bidirectional optical multiplexing system is configured to receive and transmit light. In particular, the light is received and transmitted in a bidirectional light beam external to the bidirectional optical multiplexing system. According to various examples, the external light beam includes a plurality of wavelengths and may carry information using different wavelengths of the plurality in the form of a plurality of optical signals or as a plurality of optical channels using wave division multiplexing (WDM). For example, different wavelengths of the external light beam may be assigned to carry different optical signals or to correspond to different optical channels. Further, as a bidirectional light beam, each of the different wavelengths of the external light beam may either propagate away from the bidirectional optical multiplexing system as transmitted light (i.e., transmitted optical signals) or propagate toward the bidirectional optical multiplexing system as received light (i.e., received optical signals). Operationally, the bidirectional optical multiplexing system both combines the light at different wavelengths for transmission in the external light beam and separates received light in the external light beam into different wavelengths using WDM, according to various examples.

FIG. 4 illustrates a cross-sectional view of a bidirectional optical multiplexing system 200, according to an example consistent with the principles described herein. As illustrated, the bidirectional optical multiplexing system 200 includes a beam-forming lens 210 to tilt and focus light of a light beam. According to various examples, the light beam that is focused and tilted by the beam-forming lens 210 may be both an incident portion of an external light beam 202 and a portion of an internal light beam 204 that exits or is emitted by the bidirectional optical multiplexing system 200. In some examples, the beam-forming lens 210 may be substantially similar to the beam-forming lens 110 of the bidirectional optical multiplexer 100, described above. In particular, the beam-forming lens 210 may be or include a high contrast grating (HCG) lens, according to some examples.

The bidirectional optical multiplexing system 200 further includes a plurality of reflective optical filters 220. Each reflective optical filter 220 of the plurality is configured to selectively pass a different wavelength of light in the internal light beam 204. Further, each of the reflective optical filters 220 is configured to reflect optical wavelengths that are not passed by the respective optical filter 220. According to some examples, an optical filter 220 of the plurality is substantially similar to the optical filter 120 described above with respect to the bidirectional optical multiplexer 100. For example, a first optical filter 220 of the plurality of reflective optical filters 220 may pass a first wavelength, a second optical filter 220 may pass a second wavelength, and so on. In some examples, the optical filter 220 is a dichroic optical filter. In other examples, the optical filter 220 is a grating-based optical filter such as, but not limited to, a high contrast grating-based optical filter.

The bidirectional optical multiplexing system 200 further includes a plurality of relay mirrors 230. The relay mirrors 230 of the respective plurality are configured to collimate and reflect light of the internal light beam 204 along a zigzag propagation path of the internal light beam 204 within the bidirectional optical multiplexing system 200. According to some examples, a relay mirror 230 of the plurality of relay mirrors 230 is substantially similar to the relay mirror 130 of the bidirectional optical multiplexer 100, described above. In particular, the relay mirror 230 is a high contrast grating (HCG) mirror, according to some examples.

According to some examples (e.g., as illustrated in FIG. 4), the bidirectional optical multiplexer system 200 further includes a transparent substrate 240. Further in some examples, the beam-forming lens 210 and the relay mirrors 230 are adjacent to a first surface of the transparent substrate 240 and the optical filters 220 are adjacent to a second surface of the transparent substrate 240 opposite to the first surface. For example, the beam-forming lens 210 and the relay mirrors 230 may be affixed to or otherwise supported by the first surface, while the optical filters 220 may be affixed to or otherwise supported by the second surface. One or both of the beam-forming lens 210 configured as an HCG lens and the relay mirror 230 configured as an HCG mirror may be deposited as an HCG layer on the first surface and then defined by etching in situ on the transparent substrate 240, for example. The zigzag propagation path of the internal light beam 204 may be within and along a length of the transparent substrate 240, according to some examples. In some examples, the transparent substrate 240 may be substantially similar to the transparent substrate 140 described above with respect to the bidirectional optical multiplexer 100.

The bidirectional optical multiplexing system 200 further includes a photodetector 250. In some examples (e.g., as illustrated in FIG. 4), the bidirectional optical multiplexer 200 includes a plurality of photodetectors 250. The photodetector 250 is configured to detect a portion of the internal light beam 204 at a wavelength passed by a respective reflective optical filter 220. For example, a first photodetector 250 may be positioned to receive and detect light at a first wavelength passed by a first reflective optical filter 220, as illustrated. Also illustrated is another photodetector(s) 250 that may be positioned to receive and detect light at another wavelength(s) passed by another respective optical filter(s) 220, for example.

In some examples, the photodetector 250 is a semiconductor photodetector. For example, the photodetector 250 may be a semiconductor photodetector such as, but not limited to, a p-i-n (PIN) diode photodetector. In some examples, the photodetector 250 includes a lens to focus light (e.g., received light). In some examples, the lens further tilts the light. For example, the lens may be integrated on the PIN diode photodetector.

The bidirectional optical multiplexer system 200 further includes an optical source 260. The optical source 260 is configured to emit light into the zigzag propagation path at a second wavelength as part of the internal light beam 204. For example, the optical source 260 may emit light toward a relay mirror 230 of the plurality of relay mirrors 230. In some examples, the emitted light may pass through an optical filter 220 of the plurality of optical filters 220. For example, the optical filter 220 may pass light at the second wavelength and the light emitted by the optical source 260 may pass through the optical filter 220 and on to one of the relay mirrors 230, as illustrated in FIG. 4.

In some examples, the optical source 260 is a laser. In particular, the optical source 260 may be a vertical cavity surface emitting laser (VCSEL), according to some examples. In other examples, the optical source 260 may be another optical source including, but not limited to, a light emitting diode (LED). In some examples, the optical source 260 includes a lens to focus light (e.g., the emitted light). In some examples, the lens further tilts the light. For example, the light emitted by the optical source 260 may be tilted toward one or both of an optical filter 220 and a relay mirror 230 in line with the zigzag propagation path of the internal light beam 204, as illustrated in FIG. 4. The lens of the optical source 260 may be a lens (e.g., an HCG lens) and integrated with a VCSEL, for example.

Note that an arrangement of photodetectors 250 and optical sources 260 illustrated in FIG. 4 is substantially arbitrary. Other arrangements as well as additional photodetectors 250, optical sources 260 and associated optical filters 220 and relay mirrors 230 to extend the zigzag propagation path of the internal light beam 204, while not explicitly illustrated, are explicitly within the scope described herein. For example, the photodetectors 250 and optical sources 260 may alternate.

In some examples, the bidirectional optical multiplexing system 200 further includes an optical fiber 270. The optical fiber 270 may be oriented with respect to the beam-forming lens 210 to one or both of receive a portion of the external light beam 202 propagating from the beam-forming lens 210 and to provide a portion of the external light beam 202 to the beam-forming lens 210. According to various examples, the external light beam portion received by the optical fiber 270 is light from the internal light beam 204 that has propagated in the transparent substrate 240 and that has been focused and tilted by the beam-forming lens 210. Further, the external light beam portion provided by the optical fiber 270 to the beam-forming lens 210 is light configured to propagate in the zigzag propagation path of the internal light beam 204 after focusing and tilting by the beam-forming lens 210, according to various examples.

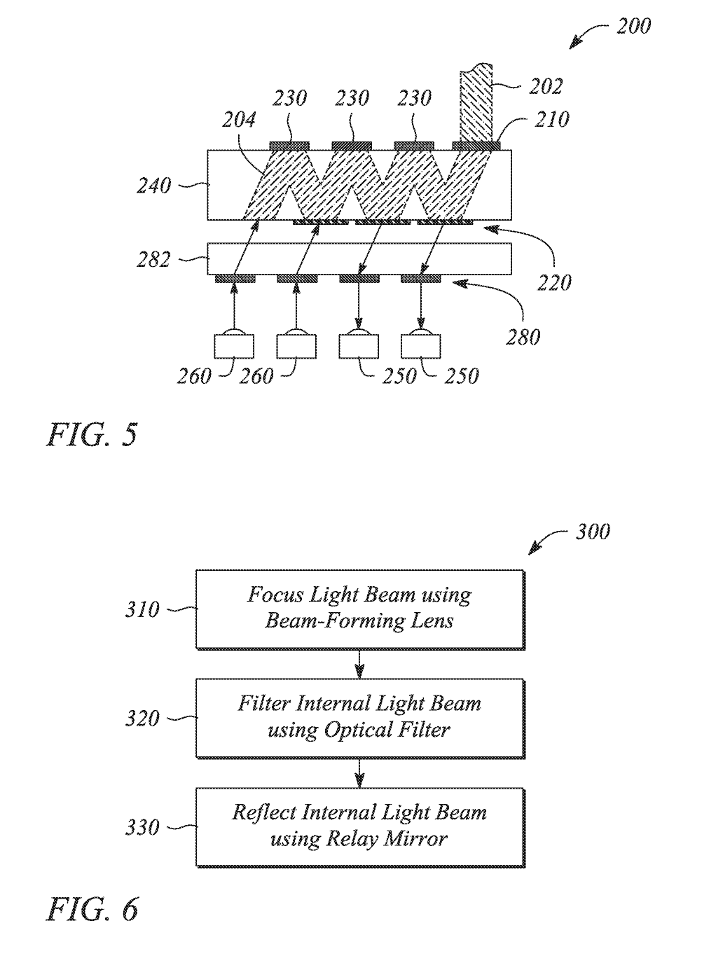

FIG. 5 illustrates cross-sectional view of a bidirectional optical multiplexing system 200, according to another example consistent with the principles described herein. In particular, FIG. 5 illustrates the bidirectional optical multiplexer system 200 including a beam-forming lens 210, a plurality of optical filters 220, a plurality of relay mirrors 230, a transparent substrate 240, a plurality of photodetectors 250, and a plurality of optical sources 260, for example, as described above. However, as illustrated in FIG. 5, the bidirectional optical multiplexing system 200 may further include a plurality of high contrast grating (HCG) lenses 280. In particular, the plurality of HCG lenses 280 is between the second surface of the transparent substrate 240 (and in some examples the plurality of optical filters 220) and both a photodetector 250 and an optical source 260 of the respective pluralities thereof, as illustrated.

The HCG lenses 280 are configured to focus light passing between either the optical filters 220 or the relay mirror(s) 230 and corresponding ones of the photodetectors 250 and the optical sources 260. For example, a first HCG lens 280 may be configured to focus light passed by a corresponding optical filter 220 onto a corresponding photodetector 250. A second HCG lens 280 may be configured to focus light emitted by an optical source 260 onto a corresponding relay mirror 230. In some examples, the light focused onto a relay mirror 230 passes through an optical filter 220 prior to reaching the relay mirror 230 in the propagation path. In some examples, the HCG lenses 280 also tilt the focused light (e.g., as illustrated). The plurality of HCG lenses 280 may be employed to correspond to respective one or both of the photodetectors 250 and the optical sources 260, or respective photodetectors 250 and optical sources 260 that do not include integrated lenses, for example. In some examples, the HCG lenses 280 may be supported by a transparent substrate 282 (e.g., as illustrated).

According some examples consistent with the principles described herein, a method of bidirectional optical multiplexing is provided. In some examples, the method of bidirectional optical multiplexing may be provided by the bidirectional optical multiplexer 100, described above. In other examples, the bidirectional optical multiplexing system 200 described above may be used to realize the method of bidirectional optical multiplexing described herein.

FIG. 6 illustrates a flow chart of a method 300 of bidirectional optical multiplexing, according to an example consistent with the principles described herein. The method 300 of bidirectional optical multiplexing includes focusing 310 a beam of light using a beam-forming lens. In some examples, focusing 310 the beam includes both focusing and tilting the light beam into a particular propagation path. In some examples, the beam-forming lens that provides beam focusing 310 is substantially similar to the beam-forming lens 110 described above with respect to the bidirectional optical multiplexer 100. In particular, according to various examples, the light beam that is focused 310 by the beam-forming lens may be one or both of an external light beam and an internal light beam of a bidirectional optical multiplexer.

The method 300 of bidirectional optical multiplexing further includes filtering 320 the internal light beam using an optical filter that selectively passes a portion of the internal light beam at a first wavelength and that reflects portions of the internal light beam at other wavelengths. The reflected portion of the internal light beam is reflected to propagate along an internal or ‘zigzag’ propagation path. According to some examples, the optical filter that provides the filtering 320 is substantially similar to the optical filter 120 of the bidirectional optical multiplexer 100, described above.

The method 300 of bidirectional optical multiplexing illustrated in FIG. 6 further includes reflecting 330 the internal light beam using a relay mirror. As a result of reflecting 330 the internal light beam, the reflected light beam follows an internal zigzag propagation path between the optical filter and the relay mirror. According to various examples, one or both of the beam-forming lens comprises a high contrast grating (HCG) lens and the relay mirror comprises an HCG mirror. In some examples, the relay mirror may further collimate the reflected internal light beam.

In some examples, the method 300 of bidirectional optical multiplexing further includes detecting a portion of the internal light beam exiting the zigzag propagation path using a photodetector. For example, the photodetector may detect a portion of the internal light beam exiting the zigzag propagation path through one of the optical filters.

In some examples, the method 300 of bidirectional optical multiplexing further includes emitting light into the zigzag propagation path using an optical light source. The light may be emitted in a direction of a relay mirror, for example, or through an optical filter in the zigzag propagation path to the relay mirror. Light may be emitted at a predetermined wavelength of the internal light beam. For example, the light may be emitted by a vertical cavity surface emitting laser (VCSEL) tuned to the predetermined wavelength.

Thus, there have been described examples of a bidirectional optical multiplexer, a bidirectional optical multiplexing system and a method of bidirectional optical multiplexing that employ a high contrast grating as one or both of a lens and a mirror. It should be understood that the above-described examples are merely illustrative of some of the many specific examples that represent the principles described herein. Clearly, those skilled in the art can readily devise numerous other arrangements without departing from the scope as defined by the following claims.

What is claimed is:

1. A bidirectional optical multiplexer comprising:
a beam-forming lens to focus a beam of light, the light beam being one or both a light beam internal to and another light beam external to the bidirectional optical multiplexer;
an optical filter to selectively pass a portion of the internal light beam at a first wavelength and to reflect portions of the internal light beam at other wavelengths; and
a relay mirror to reflect the internal light beam, the reflected internal light beam to follow a zigzag propagation path between the optical filter and the relay mirror,
wherein one or both of the beam-forming lens comprises a high contrast grating (HCG) lens and the relay mirror comprises an HCG mirror.

2. The bidirectional optical multiplexer of claim 1, further comprising:
another optical filter to selectively pass another portion of the internal light beam at a second wavelength different from the first wavelength and to reflect portions of the internal light beam at wavelengths other than the first and second wavelengths; and
another relay mirror to further reflect the internal light beam along the zigzag propagation path within the bidirectional optical multiplexer.

3. The bidirectional optical multiplexer of claim 1, wherein the optical filter comprises a wavelength-selective high contrast grating.

4. The bidirectional optical multiplexer of claim 1, wherein the relay mirror is to further collimate the reflected internal light beam, and wherein the beam-forming lens is further to tilt the light beam in a direction of a respective propagation path.

5. The bidirectional optical multiplexer of claim 1, further comprising a transparent substrate, the beam-forming lens and the relay mirror being adjacent to a first surface of the transparent substrate, the optical filter being adjacent to a second surface of the transparent substrate opposite the first surface, wherein the zigzag propagation path is within and along a length of the transparent substrate.

6. A bidirectional optical multiplexing system comprising the bidirectional optical multiplexer of claim 1, the bidirectional optical multiplexing system further comprising:
a photodetector located in a propagation path of the internal light beam portion passed by the optical filter, the photodetector to detect light at the first wavelength; and
an optical source to emit light at a wavelength reflected by the optical filter, light emitted by the optical source to propagate in a direction toward the relay mirror,
wherein the relay mirror is to reflect the emitted light toward the optical filter along the zigzag propagation path as part of the internal light beam.

7. The bidirectional optical multiplexing system of claim 6, further comprising a plurality of high contrast grating (HCG) lenses between the bidirectional optical multiplexer and both of the optical source and the photodetector, a first HCG lens of the plurality of HCG lenses to focus onto the photodetector the internal light beam portion passed by the optical filter, and wherein a second HCG lens of the plurality of HCG lenses is to focus light emitted by the optical source onto the relay mirror.

8. A bidirectional optical multiplexing system comprising:
a beam-forming lens to focus and tilt light of both an external light beam and an internal light beam;
a plurality of reflective optical filters, each reflective optical filter of the plurality of reflective optical filters to selectively pass a different wavelength of light in the internal light beam and reflect other wavelengths of the internal light beam;
a plurality of high contrast grating (HCG) relay mirrors to collimate and reflect light along a zigzag propagation path of the internal light beam between the reflective optical filters and the HCG relay mirrors;
a photodetector to detect a portion of the internal light beam at a first wavelength passed by a reflective optical filter of the plurality of reflective optical filters; and
an optical source to emit light into the zigzag propagation path at a second wavelength as part of the internal light beam.

9. The bidirectional optical multiplexing system of claim 8, further comprising a transparent substrate, the beam-forming lens and the HCG relay mirrors being spaced apart from one another and adjacent to a first surface of the transparent substrate, the reflective optical filters being spaced apart from one another and adjacent to a second surface of the transparent substrate opposite the first surface, wherein the zigzag propagation path is within and along a length of the transparent substrate between the reflective optical filters and HCG relay mirrors of the respective pluralities, and wherein the beam-forming lens is to focus the internal light beam onto a first optical filter of the plurality of reflective optical filters.

10. The bidirectional optical multiplexing system of claim 8, wherein the beam-forming lens is an HCG lens.

11. The bidirectional optical multiplexing system of claim 8, further comprising an HCG lens to focus the internal light beam portion passed by the reflective optical filter into the photodetector; and another HCG lens to focus the light emitted from the optical source into one or both of a reflective optical filter and an HCG relay mirror along the zigzag propagation path.

12. The bidirectional optical multiplexer system of claim 8, wherein each of the photodetector and the optical source comprises a lens to focus light, the optical source being a vertical cavity surface emitting laser (VCSEL) with an integrated lens.

13. The bidirectional optical multiplexer system of claim 8, further comprising an optical fiber oriented with respect to the beam-forming lens to one or both of receive a portion of the external light beam propagating from the beam-forming lens and to provide a portion of the external light beam to the beam-forming lens

14. A method of bidirectional optical multiplexing, the method comprising:
focusing a beam of light using a beam-forming lens, the light beam being one or both of an external light beam and an internal light beam;
filtering the internal light beam using an optical filter that selectively passes a portion of the internal light beam at a first wavelength and that reflects portions of the light beam at other wavelengths; and
reflecting the internal light beam using a relay mirror, the reflected internal light beam following a zigzag propagation path between the optical filter and the relay mirror,
wherein one or both of the beam-forming lens comprises a high contrast grating (HCG) lens and the relay mirror comprises an HCG mirror.

15. The method of bidirectional optical multiplexing of claim 14, further comprising:
detecting a portion of the internal light beam exiting the zigzag propagation path using a photodetector; and
emitting light into the zigzag propagation path using an optical light source,
wherein the relay mirror is to also collimate the reflected internal light beam.
